(19) United States
(12) Patent Application Publication
(10) Pub. No.: US 2016/0248251 A1
(43) Pub. Date: Aug. 25, 2016

(54) VARIABLE FEED-OUT ENERGY MANAGEMENT

(71) Applicant: QUALCOMM Incorporated, San Diego, CA (US)

(72) Inventors: Peerapol Tinnakornsrisuphap, San Diego, CA (US); Rashid Ahmed Akbar Attar, San Diego, CA (US); Shengbo Chen, San Diego, CA (US)

(21) Appl. No.: 14/925,592

(22) Filed: Oct. 28, 2015

Related U.S. Application Data
(60) Provisional application No. 62/120,239, filed on Feb. 24, 2015.

(51) Int. Cl. H02J 3/14; G05B 19/048

(52) U.S. Cl. CPC H02J 3/14; G05B 19/048; G05B 2219/2639

(57) ABSTRACT

Mechanisms and techniques for managing energy consumption within an energy management system are disclosed. In one embodiment, the energy management system includes a power generator and a management controller that controls activation of a plurality of load devices. The management controller is communicatively coupled to a meter that measures electrical energy transferred between the energy management system and an external power grid. The management controller monitors, using information from the meter, electrical energy transfer between the energy management system and the external power grid and receives a feed-out limit message from the external power grid. The management controller processes the feed-out limit message and modifies activation scheduling of at least one of the plurality of load devices based, at least in part, on processing the feed-out limit message.

### RELATED APPLICATIONS

This application claims priority to U.S. Provisional Application No. 62/120,239, filed on Feb. 24, 2015, which is incorporated herein by reference.

### TECHNICAL FIELD

Embodiments of the disclosed subject matter generally relate to the field of distributed energy source management, and more particularly to systems and methods for managing transfer of energy between a variable output allocation and local energy loads.

### BACKGROUND

Electrical grids form interconnected networks that deliver electrical power from suppliers to energy consumers. Traditionally, electrical grid power sources delivered energy from centralized, large-scale electrical generators to vast numbers of final electrical loads at consumer sites. Grid power supply management was designed to support and conform to this largely unidirectional flow of electrical energy.

Continued development of energy sources has resulted in changes in methods by which electric grids and energy utilities distribute electrical energy. Namely, technological advances have contributed to an emergence of on-site consumer energy control systems. These consumer energy control systems enable local energy generation systems, such as home-based photovoltaic systems, to supply electrical energy into the external, centralized electrical grid network. Local energy generation systems may comprise energy generators that generate electrical energy from relatively non-exhaustible sources. Such energy generators may include photovoltaic systems and wind turbine systems.

The increasing prevalence of decentralized electrical energy generators presents challenges relating to the stability of electrical grid supply. To maintain supply, energy suppliers have utilized consumer incentives to reduce energy intake from distributed sources and increase energy intake from localized sources. These consumer incentives are commonly referred to as feed-in tariffs.

### SUMMARY

Various embodiments for managing energy consumption within an energy management system are disclosed. In one embodiment, the energy management system includes a management controller configured to control activation of a plurality of load devices. The management controller processes a feed-out limit message. The feed-out limit message indicates a power limit associated with a feed-out limit period. In one embodiment, the management controller determines a predicted average surplus power level over the feed-out limit period and modifies an activation schedule of at least one of the plurality of load devices based, at least in part, on the predicted average surplus power level.

### BRIEF DESCRIPTION OF THE DRAWINGS

The present embodiments may be better understood by referencing the accompanying drawings.

FIG. 1 is a block diagram depicting an architectural overview of a networked electrical energy transfer environment, in accordance with one embodiment;

FIG. 2 is a block diagram illustrating features of a controller device, according to some embodiments;

FIG. 3 is a diagram depicting a load management messaging protocol in accordance with one embodiment;

FIG. 4A is a flow diagram illustrating processing and communications performed during load management, in accordance with one embodiment;

FIG. 4B depicts a flow diagram showing processing and communications performed during load management, in accordance with one embodiment;

FIG. 4C depicts a flow diagram showing processing and communications performed during load management, in accordance with one embodiment; and

FIG. 5 depicts an example computer system for implementing embodiments of the disclosure.

### DESCRIPTION OF EMBODIMENT(S)

The following description discloses example techniques and structures that embody the subject matter herein. However, it is understood that the described embodiments may be practiced without these specific details. In other instances, well-known instruction instances, protocols, structures and techniques have not been shown in detail in order not to obfuscate the description.

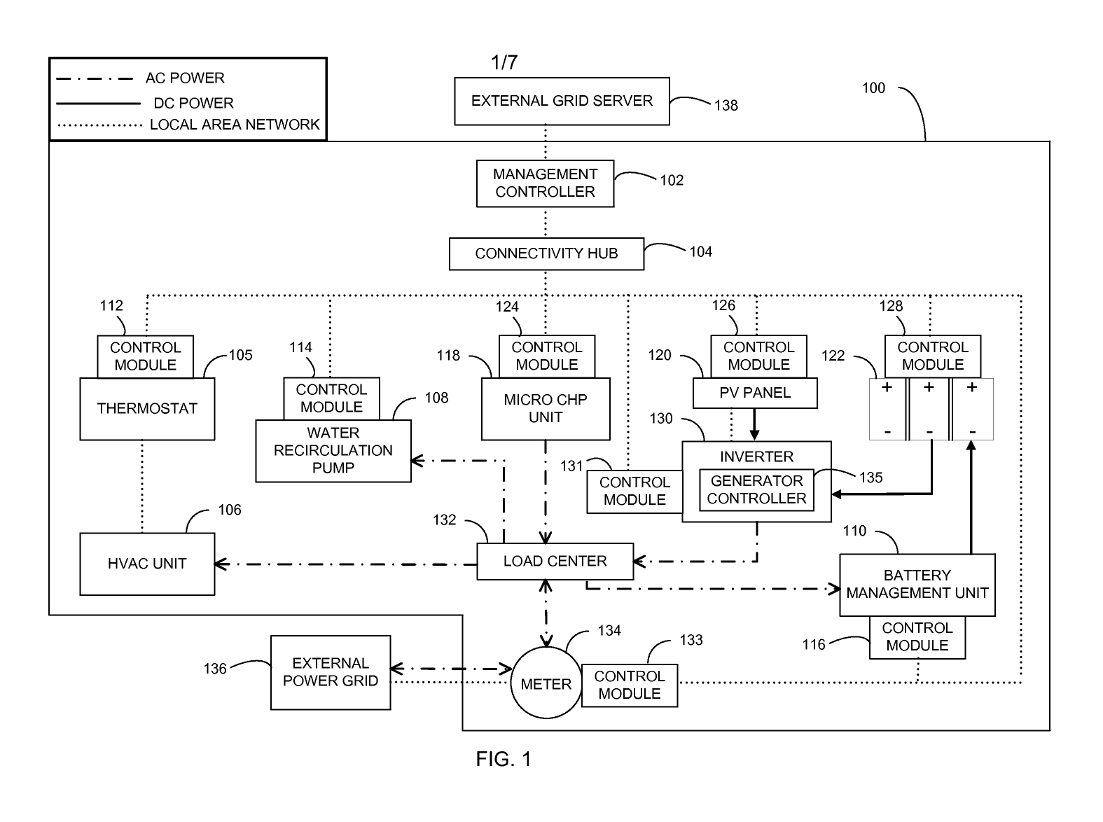

FIG. 1 is a block diagram depicting an architectural overview of a networked electrical energy transfer environment, in accordance with one embodiment. FIG. 1 shows an energy management system (EMS) 100 and an external power grid 136. The EMS 100 comprises multiple interconnected power generators and load devices. The EMS 100 may be implemented within a home, a business, or other environments. The EMS 100 may enhance energy efficiency of its load devices and subsystems, and reduce energy costs.

As shown in FIG. 1, the EMS 100 is connected to the external power grid 136, which may be connected to one or more energy sources, such as electric power plants (not depicted). The EMS 100 may both receive and transmit electrical power from and to the external power grid 136, with the exchange monitored by a meter 134. The EMS 100 includes a management controller 102, which functions as a centralized energy controller for the various energy-related devices associated with the EMS 100.

The solid, dotted, and intermittent dot-dashed lines in FIG. 1 represent communication and power transfer connections between various devices within the depicted energy transfer environment. The solid lines represent direct current (DC) power transfer. The intermittent dot-dashed lines represent alternating current (AC) power transfer. The dotted lines represent communication channels between devices. These power connections and communication channels may be unidirectional or bi-directional. For example, the devices within the EMS 100 may transmit their respective operational state information to the management controller 102 via the communication channels. The devices may determine whether to update their operational states based, at least in part, on the received data and/or control instructions.

The load devices include a heating, ventilation, and air conditioning (HVAC) unit 106 that provides temperature control within an enclosed structure, such as a home. Activation of the HVAC unit 106 is controlled by a thermostat 105. The thermostat 105 is configured to monitor the operational state of the HVAC unit 106 with respect to air temperature. The thermostat 105 may receive scheduling instructions from the management controller 102. The scheduling instructions enable scheduling of the HVAC unit 106 to coordinate scheduling with other load devices within the EMS 100, as will be discussed further below. The load devices further include a water recirculation pump 108 and a battery management unit 110.

The EMS 100 may supplement energy received from the external power grid 136 with power from local power generators. In the depicted embodiment, the EMS 100 is connected to two local power generators: a photovoltaic (PV) panel 120 and a micro combined heating and power (CHP) unit 118. The PV panel 120 is controlled, in part, by an inverter 130, which also functions to convert the direct current (DC) power generated by the PV panel 120 into alternating current (AC) power. The inverter 130 may implement maximum power point tracking and/or other techniques to improve utilization of the PV panel 120. The inverter 130 may report, to the management controller 102, an instantaneous and/or recorded energy generation rate (e.g., power measured in kW) and other power generation parameters associated with the PV panel 120. In some embodiments, the inverter 130 receives control instructions from the management controller 102.

The micro CHP unit 118 may utilize fuel from a fuel source (not shown) to generate power while simultaneously generating recoverable heat for a local enclosure. Generating power and recoverable heat may be known as cogeneration. The micro CHP unit 118 may similarly report an instantaneous and/or recorded energy generation rate and other parameters (such as the level of stored heat and/or water temperature) to the management controller 102. The management controller 102 may change the operational state of the micro CHP unit 118 based on power consumption needs and power output limitations of the EMS 100.

The EMS 100 further includes one or more local energy reserves, such as a battery 122 for storing energy locally. The battery 122 is connected to the battery management unit 110, which may monitor, charge, and discharge the battery 122. The battery management unit 110 may report, to the management controller 102, an amount of charge stored by the battery 122, an instantaneous charging or discharging rate, and recorded charging and charge levels and rates.

Local energy reserves, such as energy reserves store by the battery 122, allow the EMS 100 to store excess energy that may be either received from the external power grid 136 or generated by local power generators (e.g., the PV panel 120). The local energy reserves provided by the battery 122 can provide increased flexibility for coordinating energy consumption over a period of time. Furthermore, local energy reserves can also attenuate spikes in the net energy for be drawn from the external power grid 136 when numerous load devices are simultaneously active.

The meter 134 monitors and actuates energy transfer between the external power grid 136 and the EMS 100. A load center 132 may receive AC power from the external power grid 136 through the meter 134 and may distribute this power to various load devices. The load center 132 may also receive AC power from local energy sources, such as the micro CHP unit 118 and the inverter 130. In addition, the load center 132 may provide access for manually activating and deactivating loads and subsystems.

As further depicted in FIG. 1, the management controller 102 is connected to a connectivity hub 104. In some embodiments, the connectivity hub 104 may be implemented as a router having Wi-Fi capability. The connectivity hub 104 may function to enable the management controller 102 to communicate with the various load devices (e.g., HVAC unit 106), energy reserves (e.g., battery 122), and power generators (PV panel 120). The connectivity hub 104 may further enable the management controller 102 to communicate with external network servers, such as an external grid server 138.

For device connectivity, the loads, power generators, and energy reserves may include control modules to enable communication with the management controller 102. In the depicted embodiment, power generators, such as micro CHP unit 118 and PV panel 120, each have such control modules (124 and 126 respectively as illustrated) to both receive instructions and send data to the management controller 102 through connectivity hub 104. Similarly, load devices such as the thermostat 105, the water recirculation pump 108, and the battery management unit 110, each have respective control modules 112, 114, and 116. The inverter 130 has control module 131 and the meter 134 has control module 133. The battery 122 has control module 128. Communication may entail using established protocols for compatibility. These protocols may include Wi-Fi®, Bluetooth®, powerline communication, Zigbee®, Z-Wave, Ethernet and/or other communications protocols. The control modules may be external to or incorporated within their respective devices.

To simplify expansion of the EMS 100, the management controller 102 may support ad-hoc discovery of power generator and load devices. For example, the management controller 102 may periodically (or upon user instruction) send out a request to discover non-configured devices that include system-compliant control modules.

In some embodiments, the management controller 102 may communicate with devices within the EMS 100 using the Smart Energy Profile 2.0 (SEP2.0) standard, also known as the Institute of Electrical and Electronics Engineers P2030.5 standard. This communications standard provides an application layer specifically designed to support communications between various smart energy devices within a local area network. The SEP2.0 standard functions independent of the media access control (MAC) and physical layers of end devices (e.g., devices in the EMS 100), thereby promoting increased compatibility.

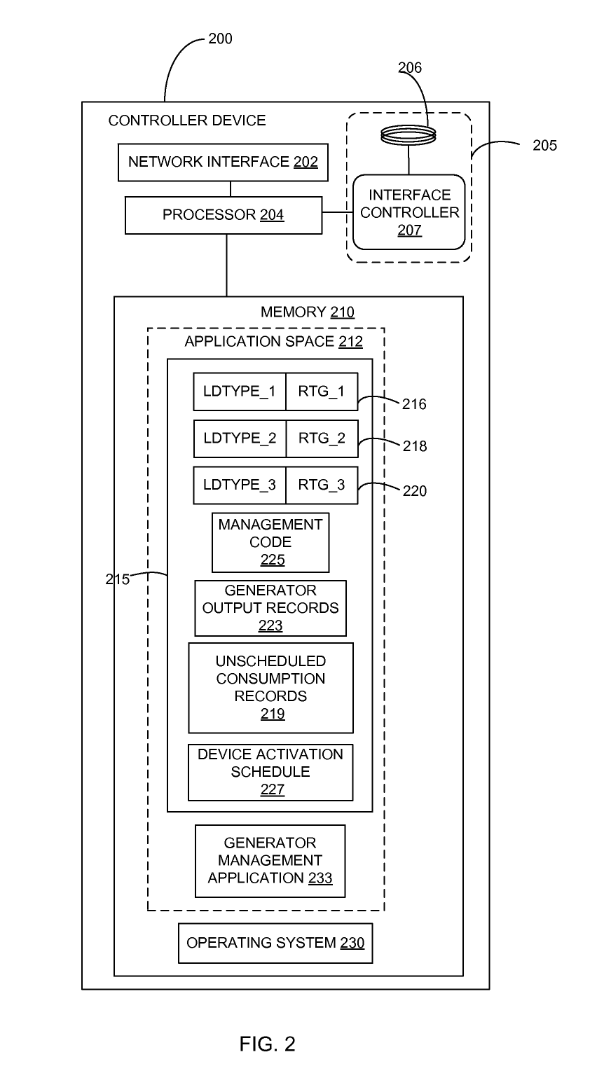

Embodiments of the management controller 102 include memory that stores machine-executable instructions that cause the management controller 102 to perform the tasks and functionalities described herein. The management controller 102 may further include and/or communicate with a resource management application (not shown in FIG. 1). The resource management application may include program instructions and data associated with load device power and energy consumption parameters, configuration, and activation schedules. The resource management application will be described in more detail below, in the discussion of FIG. 2.

The EMS 100 further includes a generator controller 135, which may be incorporated within or otherwise co-located with the inverter 130. The generator controller 135 functions to control and adjust the output power level of the PV panel 120. The generator controller 135 is communicatively coupled via the control module 131 or its own communication interface with the management controller 102, the meter 134, the external power grid 136, and the load devices.

In some other embodiments, the management controller 102 is embedded in one of the load devices, such as the thermostat 105. In some embodiments, the management controller 102 and/or the generator controller 135 is/are embedded in the connectivity hub 104. In yet other embodiments, the management controller 102 and/or the generator controller 135 and their associated functionality are distributed over multiple devices. Additionally, the management controller 102 and/or the generator controller 135 may have distributed capabilities, such as those facilitated through cloud computing facilities.

FIG. 2 is a block diagram illustrating features of a controller device, according to some embodiments. A controller device 200 may be representative of the management controller 102 and/or the generator controller 135 depicted in FIG. 1. In FIG. 2, the controller device 200 is a “smart” controller, having features extending beyond those associated with other interface-specific computer controllers. Although not shown, the controller device 200 can include user input/output systems, displays, and/or other suitable components. The controller device 200 includes a network interface 202, which may be a wireless or wireline interface for communicating with an external grid server across a network, such as the Internet. The controller device 200 further includes a processor 204 and memory 210. The memory 210 and the processor 204 cooperatively function to manage programs and data that enable the controller device 200 to perform various energy management tasks associated with local power generators and load devices. The controller device 200 further includes a communication interface 205. The communication interface 205 may support one or more of Wi-Fi®, Zigbee®, Bluetooth®, etc. The communication interface 205 includes an interface controller 207 for communicating with various power generation and load devices directly or via a hub (e.g., the connectivity hub 104 in FIG. 1). The communication interface 205 also includes an antenna 206 for generating and maintaining wireless connectivity with other interface-enabled EMS devices.

The memory 210 comprises a non-transitory machine-readable storage medium that stores programs and supporting data that control operations of the controller device 200. In the depicted embodiment, the memory 210 stores an operating system (OS) 230 and includes an application space 212 in which a resource management application 215 is maintained. OS 230 may be a flexible, multi-purpose OS such as that found in smartphones or may be an embedded OS having more limited and specialized functionality. The OS 230 generally comprises code for managing and providing services to hardware and software components within the controller device 200. Among other code and instructions, the OS 230 may include process management code comprising instructions for interfacing application code with system hardware and software. The OS 230 may also include memory management code for allocating and managing memory for use by application and system-level programs. The OS 230 may further include I/O system management code including device drivers that enable the controller's hardware to communicate with external systems, such as a user's smartphone.

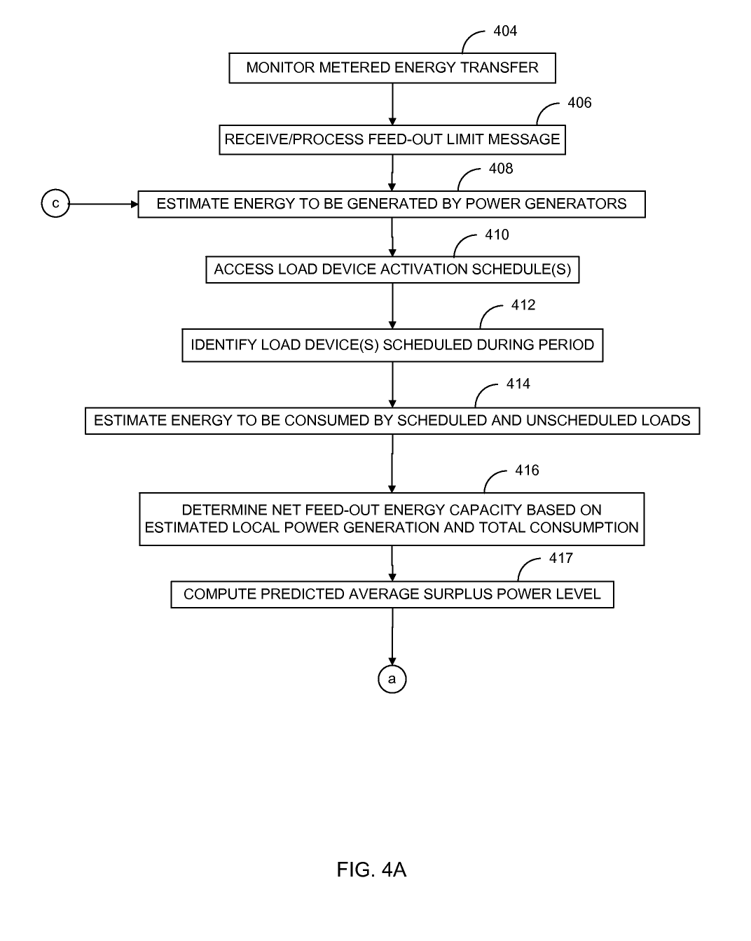

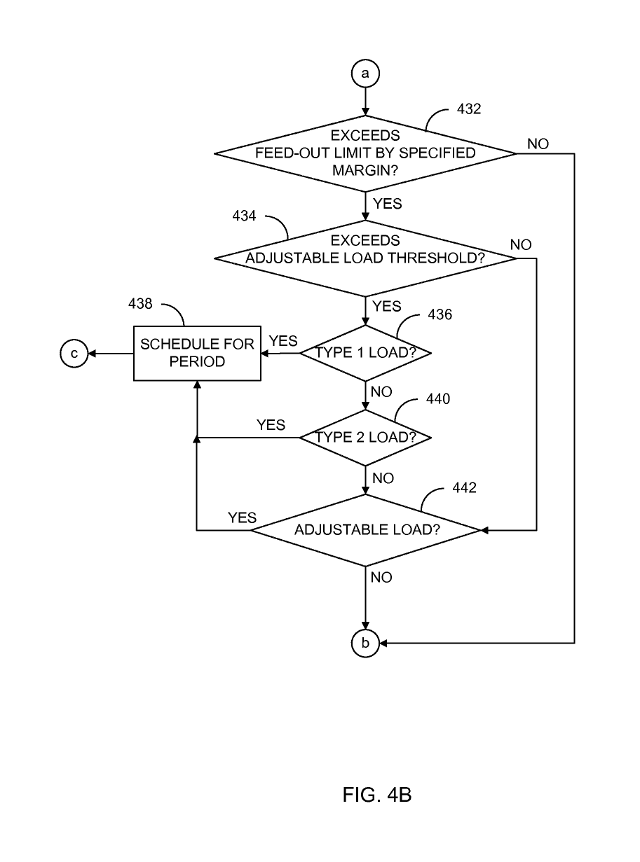

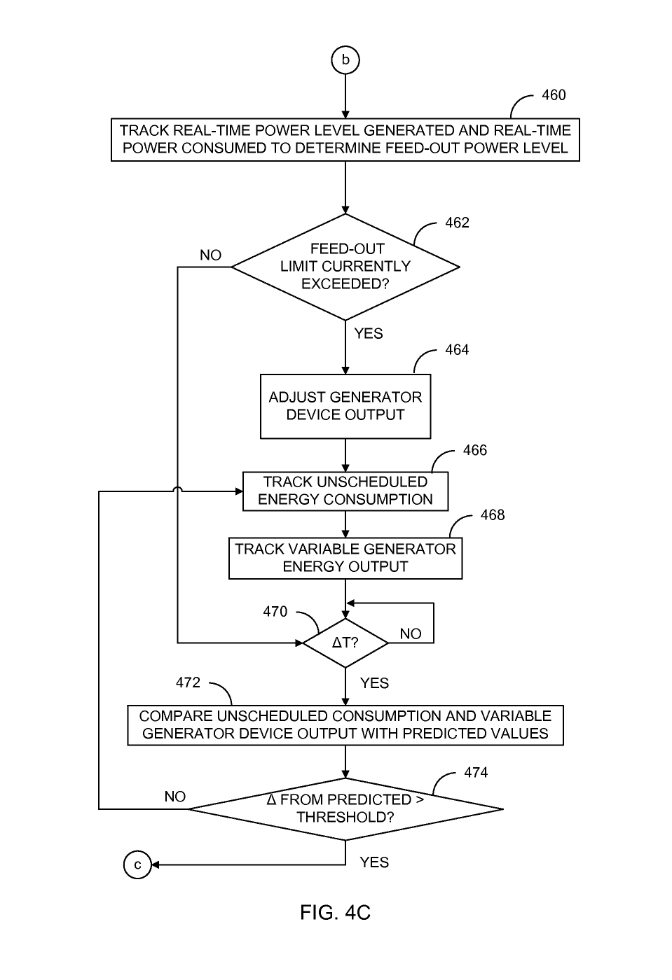

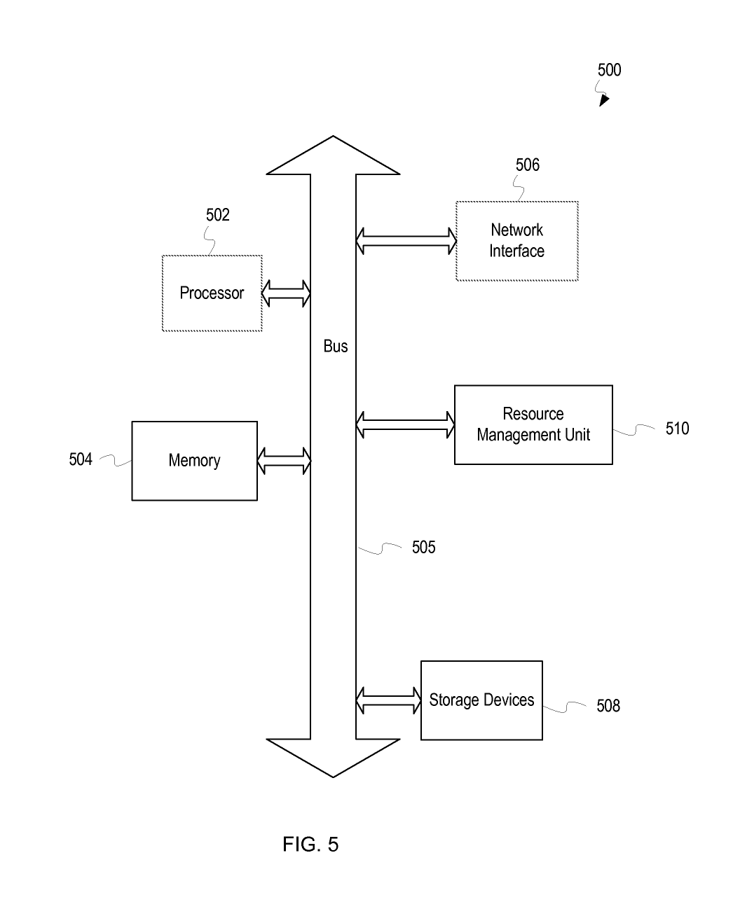

The resource management application 215 contains management code 225 (machine executable instructions) and associated data including load device power and energy consumption parameters, configuration, and activation schedules. For example, the resource management application 215 may be a user application for coordinating activation and deactivation of load devices, such as in a manner described with reference to FIGS. 4 and 5.

The resource management application 215 further includes load device entries 216, 218, and 220, each associated with a respective load device. The depicted load device entries each comprise a load category field (LDTYPE_1 for load device entry 216, LDTYPE_2 for load device entry 218, and LDTYPE_3 for load device entry 220) concatenated with or otherwise logically associated with a power rating field (RTG_1 for load device entry 216, RTG_2 for load device entry 218, and RTG_3 for load device entry 220). Each of the load category fields includes data specifying an electrical load category that the controller device 200 may apply during load device scheduling. In one embodiment, the load categories include a Type 1 load for constant power level devices. A constant power level device is one that operates at a relatively constant power level independent of scheduling by the controller device 200. For example, the water recirculation pump 108 may be in the Type 1 load. The load categories may further include a Type 2 load for devices that operate based on a duty cycle that is independent of management controller scheduling, such as the HVAC unit 106 depicted in FIG. 1. The load categories may further include a Type 3 load for variable power devices that operate at an adjustable or otherwise variable power level, such as the battery management unit 110 depicted in FIG. 1.

The resource management application 215 further comprises (or is logically associated with) generator output records 223 and unscheduled energy consumption records 219. These records may be stored in any suitable data store, such as a relational database. The generator output records 223 may store energy and/or power output parameters associated with one or more power generators, such as the PV panel 120 and the micro CHP unit 118 depicted in FIG. 1. Such parameters may be manufacturer metrics and/or may include historical power/energy output metrics measured and recorded over time within an EMS. The unscheduled energy consumption records 219 may include historical power/energy consumption metrics associated with an EMS. These metrics may indicate a cumulative power and/or energy consumption and/or consumption patterns of all unscheduled electrical loads (e.g., manually activated lights) within the EMS.

The resource management application 215 may further comprise (or otherwise be logically associated with) a device activation schedule 227 that includes scheduling information. The scheduling information can include recorded activation schedules for load devices and power generators. The device activation schedule 227 may further include instructions for activating and/or deactivating the load devices and power generators in accordance with the scheduling information. During execution of the management code 225, the controller device 200 can process the scheduling information in association with information within the load device entries 216, 218, and 220 to determine energy consumption patterns that may be processed in association with a feed-out limit message. The controller device 200 can schedule load devices based on the feed-out limit message, the energy consumption patterns, and real-time power output and energy consumption variations, as described in further detail with reference to FIG. 4. It is noted that in this disclosure, “feed-out” refers to power or energy that is generated or produced locally and supplied to an external power grid or some other external energy or power consumer. The term “feed-out” may be used interchangeably with the term “feed-in” as commonly used in the industry.

Alternately, or in addition to maintaining the resource management application 215, the application space 212 may maintain a generator management application 233. The generator management application 233 may include management code for tracking the activation status of load devices to determine real-time collective power consumption level of load devices. The generator management application 233 may further include code for comparing the collective power consumption level with a power limit specified by a feed-out limit message. In some instances, the controller device 200 is configured as a generator controller, such as generator controller 135. The generator management application 233 can provide control instructions for adjusting the output power level of a power generator (e.g., a PV panel), based on whether the current collective power consumption level exceeds a specified power limit. The discussion of FIG. 4 describes this in further detail.

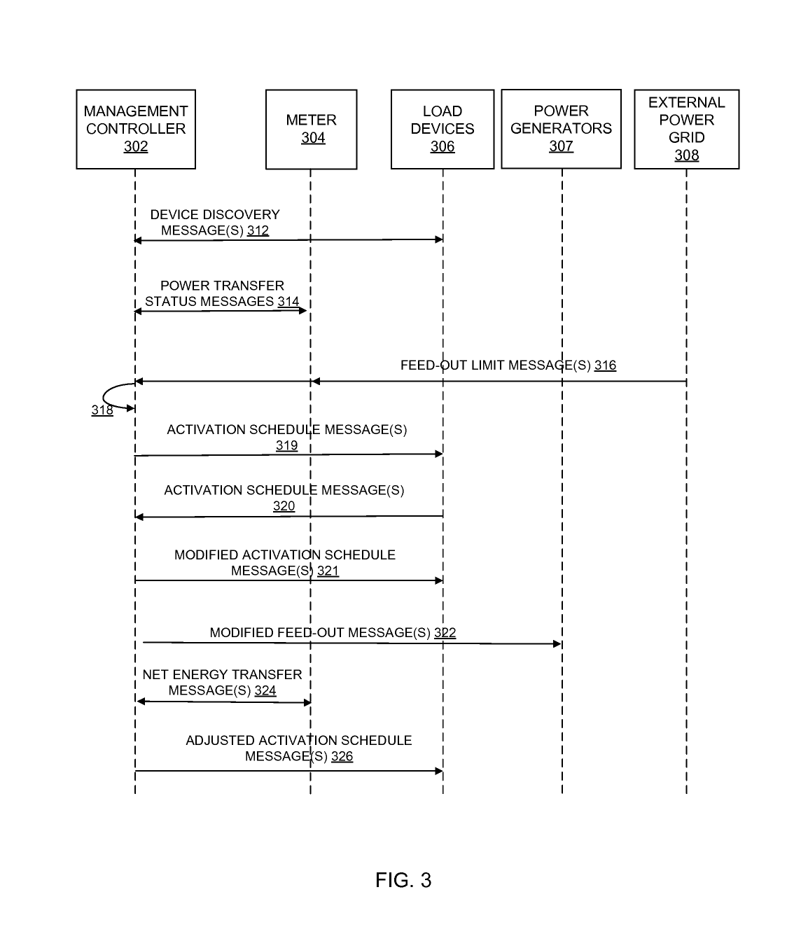

FIG. 3 is a diagram depicting a load management messaging protocol in accordance with one embodiment. The entities operably involved in the example load management messaging protocol include a management controller 302, a meter 304, one or more load devices 306, power generators 307, and an external power grid 308. The management controller 302 may include hardware and/or software for managing load activation and load activation scheduling within an energy management system. The external power grid 308 provides an external electrical power source to the energy management system that is managed by the management controller 302. The meter 304 is a device for measuring transfer of electrical energy and a power level transferred between the external power grid 308 and the energy management system. The meter 304 is communicatively and electrically coupled to both the external power grid 308 and the management controller 302. The load devices 306 are devices that consume electrical power supplied by either or a combination of power generators 307 and/or the external power grid 308. The load devices 306 may include communication interfaces, such as local wireless interfaces for communicating with the management controller 302.

As shown, the protocol begins with device discovery messages 312 between the management controller 302 and load devices 306. The management controller 302 exchanges device discovery request and response messages with one or more of the load devices 306 to obtain system information regarding the composition and configuration of load devices.

The management controller 302 monitors electrical energy transfer between the energy management system and the external power grid 308 by exchanging power transfer status messages 314 with the meter 304. While monitoring energy transfer between the energy management system and the external power grid 308, the management controller 302 receives a feed-out limit message 316 from the external power grid 308. In one embodiment, the management controller 302 receives the feed-out limit message 316 directly from the external power grid 308. Alternatively, the management controller 302 may receive the feed-out limit message 316 via the meter 304. The feed-out limit message 316 specifies a maximum power level (e.g., in kW) that may be fed-out from the energy management system to the external power grid 308. Alternatively, the feed-out limit message 316 may comprise a message that specifies a maximum energy amount or power level to be fed-out from the energy management system to the external power grid 308 over a specified period.

After receiving the feed-out limit message 316, the management controller 302 may transmit activation schedule messages 319 to one or more of the load devices 306. The management controller 302 transmits the activation schedule messages 319 to obtain activation schedule and power consumption parameters. In response, the load devices 306 may transmit activation schedule messages 320 containing activation schedule and power consumption parameters. The management controller 302 processes the activation schedule messages 320 to determine power consumption parameters. Alternatively, the management controller 302 may access the load device information via an internal memory access 318. The information received within the activation schedule messages 320 may include the identity of load devices that are currently scheduled to be activated during a feed-out limit period specified by the feed-out limit message 316. The activation schedule messages 320 may further specify the portion(s) of the feed-out limit period in which the load devices 306 are scheduled to be activated. The activation schedule messages 320 may further include power/energy consumption parameters associated with each of the currently scheduled load devices. Based on the power limit and the feed-out limit period specified by the feed-out limit message 316, and the load device schedule and power consumption parameters, the management controller 302 may modify the scheduling of one or more of the load devices over the feed-out limit period. The schedule modification may include modifying the activation periods of load devices currently scheduled to be activated during the feed-out limit period. The schedule modification may also or alternately include scheduling load devices not currently scheduled to be activated during the feed-out limit period. The management controller 302 may then generate and transmit the modified device activation schedule within a modified activation schedule message 321 to the load devices 306.

Based on the modified activation schedule message 321 and the feed-out limit message 316, the management controller 302 transmits to the power generators 307 a modified feed-out limit message 322 that may specify a limit on the power level to be generated by one of the power generators 307. The management controller 302 may further exchange net energy transfer messages 324 with the meter 304 to monitor net energy transfer between the energy management system and the external power grid 308. For example, the management controller 302 may request the net energy transferred between the energy management system and the external power grid 308 from the meter 304. The net energy transfer messages 324 may include responses from the meter 304 specifying the net energy transferred between the energy management system and the external power grid 308. The net energy transferred may be an amount of energy transferred over a period of time from the external power grid 308 to the energy management system. The net energy transferred may also or alternately be an amount of energy transferred over a period of time from the energy management system to the external power grid 308.

Using the net energy transfer messages 324, the management controller 302 can determine energy transfer metrics that enable the management controller 302 to track energy consumption of unscheduled load devices in the energy management system. An unscheduled load device may refer to load device that is not included in activation scheduling (e.g., manually activated lights and electronic devices). As described vis-à-vis FIG. 4, the unscheduled energy consumption can be determined by subtracting the scheduled energy consumption from the total energy consumption. The scheduled energy consumption may comprise the current energy consumption of scheduled devices (i.e., devices included in activation scheduling). The current energy consumption of scheduled devices may be determined by identifying which of the scheduled devices are currently activated. The activation schedule message 320 and/or the modified activation schedule message 321 may be accessed to identify which of the scheduled devices are currently activated.

The management controller 302 may process the unscheduled energy consumption and generator energy output to generate and send an adjusted activation schedule message 326 to the load devices 306. The adjusted activation schedule message 326 specifies time intervals over which one or more load devices are scheduled to be activated for all or portions of the feed-out limit period. For example, the specified feed-out limit period may be a period of 8 hours beginning at 10:30 AM to 6:30 AM on January 3. The adjusted activation schedule message 326 may include data and instructions specifying that one or more load devices be activated for one or more time intervals between 10:30 AM and 6:30 AM on January 3.

FIG. 4A is a flow diagram illustrating processing and communications performed during load management, in accordance with one embodiment. At block 404, a management controller communicates with a meter to monitor the transfer of electrical energy between an energy management system and an external power grid. The management controller can monitor the transfer of electrical energy in real-time which may include monitoring the power level measured by the meter (e.g., as measured by the meter in kilowatts (kW)). Alternately, the management controller may monitor energy transfer directly by monitoring the amount of energy measured by the meter (e.g., as measured by the meter in kilowatt hours (kWh)). Particularly, the management controller may monitor the net energy transferred into or out of the energy management system. The management controller can use the net energy amount to modify activation scheduling of load devices in the energy management system. In some instances, the management controller can use the net energy amount along with a feed-out limit message to modify activation scheduling of load devices within the energy management system.

At block 406, the management controller receives or processes a feed-out limit message while monitoring energy transfer at the meter. In one embodiment, the feed-out limit message may be received at the management controller from an external source, for example, an external power grid. In another embodiment, the feed-out limit message may be installed in the management controller at a manufacturer or distributer of the management controller. In some embodiments, multiple feed-out limit messages may be received or installed and processed by the management controller. If the feed-out limit message is transmitted, the feed-out limit message may be transmitted from an electric grid server system, or some other external source, to the meter and/or to the management controller directly.

The feed-out limit message may specify a feed-out limit (e.g., in kW) to be fed-out from the energy management system to the external power grid over a feed-out limit period. The feed-out limit message may also indicate a maximum energy amount (e.g., in kWh) to be fed-out from the energy management system to the external power grid over a feed-out limit period. In one embodiment, the feed-out limit message may indicate that during a certain time period, e.g. 1 PM-3 PM, no energy may be fed out. In another embodiment, the feed-out limit message or some other message, may indicate a value of the energy to be fed-out, e.g. how much the consumer will be paid for the fed-out energy by the power company. In this case, the management controller may make a determination based on the value of the energy, whether to feed-out the energy or use it to power local loads. At block 406, the management controller may further process the received feed-out limit message to determine the specified feed-out limit and associated feed-out limit period and in some cases may determine a value of the energy to be fed back to the external power grid.

The management controller may adjust the power level feed-out to the external power grid based on the feed-out limit message and an activation schedule, which may be modified as described herein. The schedule modification may begin with the management controller determining a predicted average surplus power level over the feed-out limit period. As shown at block 408, the management controller may estimate an amount of energy to be generated by one or more power generators within the energy management system, during the feed-out limit period. The management controller may estimate the power generators' energy output by accessing power generator activation data, which may be stored in an activation schedule (e.g., see device activation schedule 227 in FIG. 2). The activation schedule specifies which power generator(s) are scheduled to operate during, and for what portion of, the feed-out limit period. The power generator energy output data can include historical power and/or energy output data for the respective power generator devices. The management controller may also estimate the power generator devices' energy output by accessing recorded generator energy output data (e.g., generator output records 223 in FIG. 2). The power generators' energy output may be further estimated based on data such as weather forecasts, historical consumption patterns, and occupancy information.

The average surplus power level may be predicted based on the energy generation estimate and on an estimated amount of energy to be consumed over the feed-out limit period. Estimating energy consumption begins at block 410, where the management controller may access current load device activation schedule(s). At block 412, the management controller may use the current load device activation schedule(s) to identify which load devices are scheduled for activation at some point during, and for what portion of, the feed-out limit period. The load device activation schedules for each load device may be centrally maintained in memory by the management controller. In some instances, load device activation schedules may be contained in individual records maintained by the load devices. The records may be accessible to the management controller.

As shown at block 414, the management controller determines an estimate of the total scheduled and unscheduled energy consumption of the energy management system during the feed-out limit time period. The total scheduled energy consumption estimate may be computed based, at least in part, on power and/or energy rating data, such as may be obtained from the load device entries 216, 218, and 220 in FIG. 2. The total scheduled energy consumption computation may be further based on the load device activation schedule. The load activation schedule which is processed with the power and/or energy rating data to obtain the total scheduled energy consumption over the feed-out limit period. The total scheduled energy consumption may be further based on data such as weather forecasts, historical consumption patterns, and occupancy information. The management controller generates the estimated total scheduled and unscheduled energy consumption by adding the determined scheduled energy consumption with an unscheduled energy consumption value. The unscheduled energy consumption value may be estimated based on historical unscheduled power consumption data stored in unscheduled energy consumption records 219 in FIG. 2.

As shown at block 416, the management controller can determine the net feed-out energy capacity over the feed-out limit period. To determine the net feed-out energy capacity, the management controller may compare the estimated amount of energy to be generated (block 408) with the estimated total energy consumption (blocks 410-414). In one embodiment, the net feed-out energy capacity may be determined as the amount of energy by which the energy generation estimate exceeds the estimated total scheduled and unscheduled energy consumption. The management controller may determine a predicted average surplus power level (block 417) based on the determined net energy over the feed-out limit time period.

At block 432, the management controller may determine whether the average surplus power level exceeds a feed-out limit by a specified margin. The feed-out limit may be specified in a feed-out limit message, which the management controller received or stored earlier in time. If the average surplus power level does not exceed the feed-out limit by the specified margin, the process may continue at block 460 (FIG. 4C), where the management controller (or a generator controller) performs real-time tracking of the power generation and consumption. Also at block 460, the management controller may also determine a feed-out power level based on the real-time power level generated and the real-time power level consumed. If the real-time tracking reveals that the feed-out power level exceeds the feed-out limit (block 462), the management controller (or generator controller) may issue a power reduction instruction to at least one of the power generators (block 464).

In an embodiment, the specified margin may be related to a value of the energy. In this case, the management controller may determine what the costs associated with the surplus power are and how much the surplus power is worth to the external power grid. In some cases, the external power grid may offer little or no financial incentive to feed the power out to the external grid. When the specified margin is related to the value of the energy, the management controller may determine the cost of energy with and without modifying the activation schedule for the feed-out limit period in order to determine whether it is financially reasonable to modify the activation schedule. The management controller may determine to make modifications to the activation schedule that result in the most financial benefit to the consumer.

Returning to block 432 (FIG. 4B), if the average surplus power level exceeds the feed-out limit by the specified margin, the management controller determines whether the average surplus power level exceeds a power level threshold associated with an adjustable load type (block 434). In some instances, the adjustable load type may be a load that draws electrical power in an adjustable variable manner (i.e., operates at an adjustable or otherwise variable power level). For example, a battery charger is a variable power level device that would be included in this load-type category. If the adjustable load threshold is not exceeded (block 434), the management controller determines whether an adjustable load device is available to be scheduled for at least some portion of the feed-out limit period (block 442). If an adjustable load device is available, the management controller selects the adjustable load device to be scheduled for at least a portion of the feed-out limit period (block 438). From block 438, the management controller may then return to block 408 to estimate energy to be generated by the power generators.

Returning to block 434, if the average surplus power level exceeds the adjustable load threshold, the management controller begins a scheduling sequence (blocks 436, 438, 440, 442). The scheduling sequence may use load device categories to schedule loads by load types. In some embodiments, the management controller uses load types such as may be specified in load device entries 216, 218, and 220 in FIG. 2. The scheduling sequence begins at block 436. At block 436, the management controller determines whether a Type 1 load device is available to be scheduled during at least a portion of the feed-out limit period. In one embodiment, Type 1 load devices may be associated with devices that operate in a continuous manner, and at a relatively constant power level. For example, a water recirculation pump may be categorized as Type 1. The type information may be in load device records. If a Type 1 load device is available to be scheduled, the management controller schedules it for at least a portion of the feed-out limit period. If a Type 1 load device is not available to be scheduled during the feed-out limit period, the management controller determines whether a Type 2 load device is available to be scheduled during at least a portion of the feed-out limit period (block 440). In one embodiment, Type 2 load devices operate based on a duty cycle that is independent of management controller scheduling (i.e., powers off and on during scheduled activation). For example, a thermostat controlled HVAC system may be categorized as a Type 2 load device. If a Type 2 load device is available to be scheduled, the management controller schedules it for at least a portion of the feed-out limit period. If a Type 2 load device is not available to be scheduled during the feed-out limit period, the management controller determines whether an adjustable load device is available to be scheduled during at least a portion of the feed-out limit period (block 442). If an adjustable load device is not available to be scheduled during the feed-out limit period, the process continues to step 460. In some embodiments, more or less than three types of loads may be present and each type of load may be iteratively checked based characteristics of the load type.

The management controller may modify schedules in a modular manner that schedules Type 1 load devices before scheduling type 2 load devices. After each additional load device is scheduled (at block 438), the predicted average surplus power level (determined at blocks 408-417) incrementally decreases. After scheduling of Type 1 and Type 2 loads, the management controller schedules adjustable load devices for the feed-out limit period (blocks 442 and 438) to consume at least a portion of the remaining surplus power level. In this embodiment, the management controller may schedule loads of known types (e.g., Type 1 and Type 2) prior to scheduling adjustable loads.

Returning to block 460 in FIG. 4C, the management controller may commence or continue real-time tracking of the power generation and consumption. If the real-time tracking indicates a feed-out power level that exceeds the feed-out limit specified by the feed-out limit message (block 462), the management controller or generator controller may issue a power reduction instruction to at least one of the generator devices (block 464).

At blocks 466 the management controller monitors the amount of energy consumed by unscheduled load devices (e.g., personal electronic devices and other manually activated/deactivated devices). At block 468, the management controller monitors the amount of energy generated by variable power generators, such as a PV panel. The management controller monitors these potentially variable energy metrics over a time interval, ΔT, (block 470) to determine whether additional schedule modification is needed before the start of, and/or during, the feed-out limit period. In one embodiment, the management controller may determine the total energy consumption of all currently active/operating, scheduled and unscheduled, load devices over ΔT. The management controller may determine the currently active/operating unscheduled energy consumption by subtracting the energy consumption of all currently active/operating scheduled devices from the total energy consumption. The management controller may track the actual energy output of one or more power generators within the energy management system. In one embodiment, the management controller determines the actual energy output from one or more of the power generators based on measurement data from the meter or from generator-incorporated power/energy output measurement devices.

As shown at block 470, the generator output and unscheduled energy consumption information may be collected over ΔT to determine actual energy generation and unscheduled energy consumption values. The unscheduled energy consumption value may refer to currently active devices that were not scheduled. At block 472, the management controller compares the actual energy generation and unscheduled energy consumption values with the predictively estimated energy generation and unscheduled energy consumption values processed at blocks 408 and 414 in FIG. 4A. In response to the actual energy generation and unscheduled energy consumption values diverging from the predictively estimated values by a margin (block 474), the average surplus power level is again predictively estimated (blocks 408-417). This predictive estimation may be based, at least in part, on the determined actual energy generation and unscheduled energy consumption values. The activation schedule is adjusted accordingly (again modified) as shown with the process beginning again at block 432. If the divergence between the actual and predicted values does not exceed the threshold, energy generation and unscheduled energy consumption tracking continues (block 466).

FIG. 5 depicts an example computer system for implementing embodiments of the disclosure. In FIG. 5, a computer system 500 having a resource management unit 510. The computer system 500 includes a processor 502, but may include multiple processors, multiple cores, and/or multiple nodes. The computer system 500 includes memory 504 which may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The computer system 600 also includes a bus 505 (e.g., PCI, ISA, PCI-Express, HyperTransport®, InfiniBand®, NuBus, etc.), a network interface 506 (e.g., an Ethernet interface, a Frame Relay interface, Synchronous Optical Network interface, wireless interface, etc.), and a storage device(s) 508 (e.g., optical storage, magnetic storage, etc.). Resource management unit 510 embodies functionality to implement features described above with reference to FIGS. 1-4. Resource management unit 510 may perform operations that facilitate energy management within an environment in which energy is transferred between an energy management system and an external power grid. Resource management unit 510 may perform system management operations including modifying device activation scheduling based on a received feed-out limit message. Any one of these operations may be partially (or entirely) implemented in hardware and/or on processor 502. For example, the functionality may be implemented with an application specific integrated circuit, in logic implemented in processor 502, in a co-processor on a peripheral device or card, etc. Further, realizations may include fewer or additional components not illustrated in FIG. 5 (e.g., additional network interfaces, peripheral devices, etc.).

It should be understood that FIGS. 1-5 are examples meant to aid in understanding embodiments and should not be used to limit embodiments or limit scope of the claims. Embodiments may perform additional operations, fewer operations, operations in a different order, operations in parallel, and some operations differently. In some embodiments, the management controller can implement the operations of FIG. 4 individually or in combination with other devices.

As will be appreciated by one skilled in the art, aspects of the disclosed subject matter may be embodied as a system, method or computer program product. Accordingly, embodiments of the disclosed subject matter may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, embodiments of the disclosed subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While the embodiments are described with reference to various implementations and exploitations, it will be understood that these embodiments are illustrative and that the scope of the disclosed subject matter is not limited to them.

What is claimed is:

1. A method for managing loads within an energy management system that includes a management controller configured to control activation of a plurality of load devices, the method comprising:
the management controller,
determining a power limit associated with a feed-out limit period based, at least in part, on a feed-out limit message;
determining an average surplus power level over the feed-out limit period; and
modifying an activation schedule of at least one of the plurality of load devices based, at least in part, on the average surplus power level and the feed-out limit message.

2. The method of claim 1, wherein determining the average surplus power level comprises:
estimating a first amount of energy to be generated by a power generator during the feed-out limit period; and
estimating a second amount of energy to be consumed by the plurality of load devices over the feed-out limit period.

3. The method of claim 2, wherein determining the average surplus power level comprises:
comparing the first amount of energy to be generated with the second amount of energy to be consumed; and
determining the average surplus power level over the feed-out limit period based, at least in part, on the comparing.

4. The method of claim 2, wherein estimating the second amount of energy to be consumed comprises identifying one or more of the plurality of load devices that are scheduled to be activated during the feed-out limit period.

5. The method of claim 4, wherein estimating the second amount of energy to be consumed comprises:
determining power consumption parameters associated with the one or more of the plurality of load devices; and
estimating an unscheduled energy consumption value over the feed-out limit period.

6. The method of claim 1, further comprising:
the management controller,
determining a feed-out power level based, at least in part, on real-time power generation by a power generator and real-time power consumption of the plurality of load devices;
determining whether the feed-out power level exceeds the power limit; and
adjusting an output power level of the power generator based, at least in part, on determining whether the feed-out power level exceeds the power limit.

7. The method of claim 1, further comprising:
the management controller,
transferring power to an external power grid, the power generated by a power generator; and
adjusting the power transferred to the external power grid based, at least in part, on the feed-out limit message and the modified activation schedule.

8. The method of claim 1, wherein modifying the activation schedule further comprises:
the management controller,
determining whether the average surplus power level exceeds the power limit by a specified margin; and
determining to modify device activation scheduling based, at least in part, on determining that the average surplus power level exceeds the power limit by the specified margin.

9. The method of claim 1, wherein the plurality of load devices comprises a variable power level device and a constant power level device, and modifying the activation schedule comprises:
determining whether the average surplus power level exceeds an adjustable load threshold;
in response to determining that the average surplus power level exceeds the adjustable load threshold, selecting the constant power level device to be activated during the feed-out limit period;
determining a second average surplus power level based, at least in part, on selecting the constant power level device to be activated during the feed-out limit period; and
determining whether to schedule the variable power level device or another constant power level device based, at least in part, on the second average surplus power level.

10. The method of claim 1, further comprising:
following modifying the activation schedule, the management controller,
determining energy consumption by at least one unscheduled load device; and
adjusting the activation schedule based, at least in part, on the energy consumption by the at least one unscheduled load device.

11. The method of claim 1, further comprising:
determining a value of the average surplus power level, wherein modifying the activation schedule is further based, at least in part, on the value of the average surplus power level.

12. A management controller that controls activation of a plurality of load devices within an energy management system, the management controller comprising:
a processor; and
memory to store instructions, which when executed by the processor, cause the management controller to:
determine a power limit associated with a feed-out limit period based, at least in part, on a feed-out limit message;
determine an average surplus power level over the feed-out limit period; and
modify an activation schedule of at least one of the plurality of load devices based, at least in part, on the average surplus power level and the feed-out limit message.

13. The management controller of claim 12, wherein the instructions, which when executed by the processor, cause the management controller to:
estimate a first amount of energy to be generated by a power generator during the feed-out limit period; and
estimate a second amount of energy to be consumed by the plurality of load devices over the feed-out limit period.

14. The management controller of claim 13, wherein the instructions, which when executed by the processor, cause the management controller to:
compare the first amount of energy to be generated with the second amount of energy to be consumed; and
determine the average surplus power level over the feed-out limit period based, at least in part, on the comparing.

15. The management controller of claim 13, wherein estimating the second amount of energy to be consumed comprises identifying one or more of the plurality of load devices that are scheduled to be activated during the feed-out limit period.

16. The management controller of claim 15, wherein estimating the second amount of energy to be consumed comprises:
determining power consumption parameters associated with the one or more of the plurality of load devices; and
estimating an unscheduled energy consumption value over the feed-out limit period.

17. The management controller of claim 12, wherein the instructions, which when executed by the processor, cause the management controller to:
determine a feed-out power level based, at least in part, on real-time power generation by a power generator and real-time power consumption of the plurality of load devices;
determine whether the feed-out power level exceeds the power limit; and
adjust an output power level of the power generator based, at least in part, on determining whether the feed-out power level exceeds the power limit.

18. The management controller of claim 12, wherein the instructions, which when executed by the processor, cause the management controller to:
transfer power to an external power grid, the power generated by a power generator; and
adjust the power transferred to the external power grid based, at least in part, on the feed-out limit message and the modified activation schedule.

19. The management controller of claim 12, wherein the instructions, which when executed by the processor, cause the management controller to:
determine whether the average surplus power level exceeds the power limit by a specified margin; and
modify device activation scheduling based, at least in part, on determining that the average surplus power level exceeds the power limit by the specified margin.

20. The management controller of claim 12, wherein the plurality of load devices comprises a variable power level device and a constant power level device, and wherein the instructions, which when executed by the processor, cause the management controller to:
determine whether the average surplus power level exceeds an adjustable load threshold;
select, in response to determining that the average surplus power level exceeds the adjustable load threshold, the constant power level device to be activated during the feed-out limit period;
determine a second average surplus power level based, at least in part, on selecting the constant power level device to be activated during the feed-out limit period; and
determine whether to schedule the variable power level device or another constant power level device based, at least in part, on the second average surplus power level.

21. The management controller of claim 12, wherein the instructions, which when executed by the processor, cause the management controller to:
following modifying the activation schedule,
determine energy consumption by at least one unscheduled load device; and
adjust the activation schedule based, at least in part, on the energy consumption by the at least one unscheduled load device.

22. The management controller of claim 12, wherein the instructions, which when executed by the processor, cause the management controller to:
determine a value of the average surplus power level, wherein modifying the activation schedule is further based, at least in part, on the value of the average surplus power level.

23. A non-transitory machine-readable storage medium having machine executable instructions stored therein, the machine executable instructions comprising instructions to:
determine a power limit associated with a feed-out limit period, the power limit based, at least in part, on a feed-out limit message;
determine an average surplus power level over the feed-out limit period; and
modify an activation schedule of at least one of a plurality of load devices based, at least in part, on the average surplus power level and the feed-out limit message.

24. The non-transitory machine-readable storage medium of claim 23, wherein the instructions to determine the average surplus power level comprise instructions to:
estimate a first amount of energy to be generated by a power generator during the feed-out limit period; and
estimate a second amount of energy to be consumed by the plurality of load devices over the feed-out limit period.

25. The non-transitory machine-readable storage medium of claim 24, wherein the instructions to estimate the average surplus power level comprise instructions to:
compare the first amount of energy to be generated with the second amount of energy to be consumed; and
determine the average surplus power level over the feed-out limit period based, at least in part, on comparing the first amount of energy to be generated with the second amount of energy to be consumed.

26. The non-transitory machine-readable storage medium of claim 24, wherein the instructions to estimate the second amount of energy to be consumed comprise instructions to identify one or more of the plurality of load devices that are scheduled to be activated during the feed-out limit period.

27. The non-transitory machine-readable storage medium of claim 26, wherein the instructions to estimate the second amount of energy to be consumed comprise instructions to:
determine power consumption parameters associated with the one or more of the plurality of load devices; and
estimate an unscheduled energy consumption value over the feed-out limit period.

28. The non-transitory machine-readable storage medium of claim 23, further comprising instructions to:
determine a feed-out power level based, at least in part, on real-time power generation by a power generator and real-time power consumption of the plurality of load devices;
determine whether the feed-out power level exceeds the power limit; and
adjust an output power level of the power generator based, at least in part, on determining whether the feed-out power level exceeds the power limit.

29. The non-transitory machine-readable storage medium of claim 23, further comprising instructions to:
transfer power to an external power grid, the power generated by a power generator; and
adjust the power transferred to the external power grid based, at least in part, on the feed-out limit message and the modified activation schedule.

30. The non-transitory machine-readable storage medium of claim 23, wherein the instructions to modify the activation schedule comprise instructions to:
determine whether the average surplus power level exceeds the power limit by a specified margin; and
determine to modify device activation scheduling based, at least in part, on determining that the average surplus power level exceeds the power limit by the specified margin.

31. The non-transitory machine-readable storage medium of claim 23, wherein the plurality of load devices includes a variable power level device and a constant power level device, and wherein the instructions to modify the activation schedule comprise instructions to:
determine whether the average surplus power level exceeds an adjustable load threshold;
select, in response to determining that the average surplus power level exceeds the adjustable load threshold, the constant power level device to be activated during the feed-out limit period;
determine a second average surplus power level based, at least in part, on selecting the constant power level device to be activated during the feed-out limit period; and
determine whether to schedule the variable power level device or another constant power level device based, at least in part, on the second average surplus power level.

32. The non-transitory machine-readable storage medium of claim 23, further comprising instructions to:
following modifying the activation schedule,
determine energy consumption by at least one unscheduled load device; and
adjust the activation schedule based, at least in part, on the energy consumption by the at least one unscheduled load device.

33. The non-transitory machine-readable storage medium of claim 23, further comprising instructions to:
determine a value of the average surplus power level, wherein modifying the activation schedule is further based, at least in part, on the value of the average surplus power level.

34. A management controller that controls activation of a plurality of load devices within an energy management system, the management controller comprising:
means for determining a power limit associated with a feed-out limit period, the power limit based, at least in part, on a feed-out limit message;
means for determining an average surplus power level over the feed-out limit period; and
means for modifying an activation schedule of at least one of the plurality of load devices based, at least in part, on the average surplus power level and the feed-out limit message.

35. The management controller of claim 34 further comprising:
means for estimating a first amount of energy to be generated by a power generator during the feed-out limit period; and
means for estimating a second amount of energy to be consumed by the plurality of load devices over the feed-out limit period.

36. The management controller of claim 35 further comprising:
means for comparing the first amount of energy to be generated with the second amount of energy to be consumed; and
means for determining the average surplus power level over the feed-out limit period based, at least in part, on comparing the first amount of energy to be generated with the second amount of energy to be consumed.

37. The management controller of claim 35 further comprising means for identifying one or more of the plurality of load devices that are scheduled to be activated during the feed-out limit period.

38. The management controller of claim 37 further comprising:
means for determining power consumption parameters associated with the one or more of the plurality of load devices; and
means for estimating an unscheduled energy consumption value over the feed-out limit period.

39. The management controller of claim 34 further comprising:
means for determining a feed-out power level based, at least in part, on real-time power generation by a power generator and real-time power consumption of the plurality of load devices;
means for determining whether the feed-out power level exceeds the power limit; and
means for adjusting an output power level of the power generator based, at least in part, on determining whether the feed-out power level exceeds the power limit.

40. The management controller of claim 34 further comprising:
means for transferring power to an external power grid, the power generated by a power generator; and
means for adjusting the power transferred to the external power grid based, at least in part, on the feed-out limit message and the modified activation schedule.

41. The management controller of claim 34 further comprising:
means for determining whether the average surplus power level exceeds the power limit by a specified margin; and
means for determining to modify device activation scheduling based, at least in part, on determining that the average surplus power level exceeds the power limit by the specified margin.

42. The management controller of claim 34 further comprising:
means for determining whether the average surplus power level exceeds an adjustable load threshold;
means for selecting a constant power level device to be activated during the feed-out limit period in response to determining that the average surplus power level exceeds the adjustable load threshold;
means for determining a second average surplus power level based, at least in part, on selecting the constant power level device to be activated during the feed-out limit period; and
means for determining whether to schedule a variable power level device or another constant power level device based, at least in part, on the second average surplus power level.

43. The management controller of claim 34, further comprising:
means for determining energy consumption by at least one unscheduled load device; and
means for adjusting the activation schedule based, at least in part, on the energy consumption by the at least one unscheduled load device.

44. The management controller of claim 34, further comprising:
means for determining a value of the average surplus power level; and
means for modifying the activation schedule further based, at least in part, on the value of the average surplus power level.
